(19) United States
(12) Patent Application Publication
(10) Pub. No.: US 2007/0155879 A1
(43) Pub. Date: Jul. 5, 2007

(54) Adhesive compositions for bonding metals

(75) Inventors: Samuel B. Osae, Cary, NC (US); Paul C. Briggs, Chapel Hill, NC (US)

Correspondence Address: SCOTT R. COX;LYNCH, COX, GILMAN & MAHAN, P.S.C., 500 WEST JEFFERSON STREET, SUITE 2100, LOUISVILLE, KY, 40202, US

(73) Assignee: IPS Corporation, Compton, CA (US)

(21) Appl. No.: 11/643,543

(22) Filed: Dec. 21, 2006

Related U.S. Application Data
(60) Provisional application No. 60/753,310, filed on Dec. 22, 2005.

(51) Int. Cl. C08K 5/05

(52) U.S. Cl. 524/376; 524/386

(57) ABSTRACT

A two-part structural adhesive composition particularly for use with metals comprising one or more vinyl monomers, preferably an acrylate or methacrylate ester monomer, one or more soluble or dispersible polymers, and acetylenic diol adhesion promoter, and preferably one or more polymerizable acid adhesion promoters.

### CROSS REFERENCE TO RELATED APPLICATION

This application claims priority from Provisional Application No. 60/753,310, filed on Dec. 22, 2005.

### BACKGROUND AND A PREFERRED EMBODIMENT

A preferred embodiment of this invention relates to two-part structural adhesive compositions, utilizing new and unique adhesion promoters, exhibiting improved adhesion to metals, as well as other important characteristics.

These adhesive compositions are mixtures of acrylate or methacrylate monomers and polymers that comprise at least the following components:
A. one or more vinyl monomers, preferably an acrylate or methacrylate ester monomer,
B. one or more soluble or dispersible polymers, and
C. an acetylenic diol adhesion promoter.
   Preferably one or more polymerizable acidic adhesion promoters are also added to the composition.

Other additives may also be added to the composition to enhance its performance.

In the course of evaluating the effects of traditional acidic adhesion promoters for bonding metallic substrates, it was surprisingly discovered that the addition of an acetylenic diol produced a marked improvement in the ability of the composition to bond to a variety of metals, even when conventional metal bonding adhesion promoters fail to provide the desired level of adhesion.

The acetylenic diol adhesion promoters of a preferred embodiment of this invention correspond to the general formula: 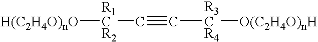
wherein R₁, R₂, R₃, and R₄ are selected from H and alkyl groups and wherein ₙ is equal to or greater than 0.

One group of preferred acetylenic diol adhesion promoters are disclosed by U.S. Pat. Nos. 4,650,543 and 3,268,593, the entirety of each is incorporated by reference herein. A particularly preferred acetylenic diol adhesion promoter is 2-butyne-1,4-diol wherein R₁, R₂, R₃, and R₄ are all H and n=0. Another particularly preferred acetylenic diol adhesion promoter, sold commercially as SURFYNOL® 104 by Air Products and Chemicals, Inc., is 2,4,7,9-tetramethyl-5-decyne-4,7-diol, wherein R₁ and R₃ are methyl groups and R₂ and R₄ are isobutyl groups and n=0. One important feature of the preferred acetylenic diols is the 2-butyne-1,4-diol backbone structure, wherein the hydroxyl groups are attached to the carbon atom adjacent to the acetylenic triple bond. Other particularly preferred acetylenic diol adhesion promoters include ethoxylated 2-butyne-1,4-diols, wherein the hydroxyl moiety is separated from the acetylenic carbon atom by one or more oxyethylene groups (n=1 or more), such as SURFYNOL 485, which is an ethoxylated 2,4,7,9 tetramethyl-5-decyn-4,7 diol.

Conventionally, acetylenic diols are sold commercially as defoaming agents and surfactants for a wide variety of aqueous or waterborne applications, such as paints and coatings. Heretofore, their use in adhesives has been limited to waterborne compositions based on polymer emulsions and water-compatible additives. They are not recommended for use in organic coatings or adhesives when organic solvents or monomers are the primary liquid species in the composition. Even when acetylenic alcohols or diols are used in water-based compositions, their benefits are generally limited to effects deriving from their function as a defoamer or surfactant. Therefore, the significant improvement in adhesion to a variety of metallic surfaces by use of the compositions of preferred embodiments of invention was surprising.

While not intending to be bound by a specific theory, possible explanations for the beneficial effects from the use of the acetylenic diol adhesion promoters may derive from one or more of the theoretical explanations for metal adhesion. These theories include, but are not limited to, various electron donor-acceptor, hydrogen bonding or dipole-dipole interactive phenomena. In this sense, the acetylenic diols adhesion promoters have the potential to function in at least two ways, wherein either the electron donating capability of the acetylenic moiety, or the hydrogen bonding capability of the hydroxyl moieties, or both, can participate in the adhesion process. Evidence may be found in the fact that the olefinic or double bond analog of the preferred 2-butyne, 1,4-diol, namely 2-butene, 1,4-diol, wherein the triple bond of the structure above is replaced by a double bond, does not impart the inventive improvements. Similarly, the bis (acetate ester) of 2,butyne-1,4-diol does not impart the same inventive improvements. Thus, it is believed that the presence of at least one hydroxyl moiety and the triple bond are necessary to impart the desired improvements.

While the preferred inventive additives may be added to the composition as the sole adhesion promoter, they find particular utility in combination with other acidic adhesion promoters. The ability of acidic adhesion promoters to affect the bond strength of acrylate or methacrylate based structural adhesives to metals is known in the art. Traditional acidic adhesion promoters include unsaturated mono-carboxylic acids, such as acrylic acid and methacrylic acid, unsaturated dicarboxylic acids such as maleic acid and fumaric acid, and unsaturated phosphoric acid esters such as mono- and bis-methacroyloxyethyl phosphate.

The factors influencing the ability of acrylate or methacrylate structural adhesives to bond metals are complex and interactive. They involve the catalytic or inhibitive effect of metallic surfaces and the acidic adhesion promoters on the reactivity of the adhesive composition as well as the effects of the specific metallic surfaces on the initial adhesion and durability of the bonds. For example, zinc and copper can either catalyze or inhibit the cure of an adhesive depending on the specific formulation. Iron oxide and aluminum oxide on ferrous and aluminum surfaces behave differently with respect to initial bond strength and durability of bonds.

Acrylic and methacrylic acids generally enhance the ability of acrylate and methacrylate structural adhesives to bond ferrous metals and generally increase their rate of cure. Maleic acid generally enhances adhesion to zinc surfaces, and unsaturated phosphoric acid esters generally enhance adhesion and durability of bonds to unprepared aluminum and stainless steel surfaces. Combinations of these acidic adhesion promoters can be used to formulate adhesives for specific applications and combinations of metallic and non-metallic materials.

One basis for a preferred embodiment of the current invention is that even when prior art metal adhesion promoters have been evaluated or incorporated in certain adhesive formulations, a specific formulation, even with certain other desirable characteristics, may not provide the desired level of adhesion to one or more metallic substrates. In such formulations, the addition of the preferred inventive acetylenic diol adhesion promoter can impart the desired improvements in metal adhesion. The specific improvements include, but are not limited to, increased bond strength and an increase in the desired cohesive failure mode over the less desirable adhesive failure mode, and preferably both. Cohesive failure is the mode of bond failure wherein upon separation of the bond in testing or in use, the failure occurs within the adhesive layer, leaving adhesive on both of the substrate pieces. In the adhesive failure mode, the adhesive separates cleanly from one of the substrate pieces, leaving no adhesive residue on that surface.

Detailed information concerning groups of adhesives to which this preferred inventive composition may be directed can be found in the U.S. Pat. Nos. 3,890,407, 4,182,604, 4,223,115, 4,536,546, 4,645,810, 4,714,730, 4,942,201, and a review of the subject by D. J. Damico, Engineered Materials Handbook, Volume 3, 119 ASM International, 1990, all of which references are incorporated herein by reference.

For purpose of this discussion, the polymerizable vinyl, acrylate and methacrylate monomers include those disclosed in the '604 patent cited above; and the soluble or dispersible polymers include those disclosed in the '604 and '546 patents. The catalysts or initiating species include all of those generally recognized in the prior art including those described in the above cited references.

A particularly preferred composition of the current invention comprises:
A. About 20 percent to about 90 percent of a polymerizable vinyl monomer, preferably an acrylate or methacrylate ester monomer,
B. About 10 percent to about 60 percent of a soluble or dispersible polymer or mixture of polymers, and
C. About 0.1 percent to about 10 percent of an acetylenic diol.

Preferably, the composition also includes about 0.5 to about 20 percent of an polymerizable acidic adhesion promoter or a mixture thereof.

Other additives to enhance the performance of the composition can be added, as needed.

### EXAMPLES

The components used in the following examples are:

| Component | Description | Supplier |
|---|---|---|
| Methyl Methacrylate | Monomer | Lucite |
| Methacrylic Acid | Polymerizable carboxylic acid adhesion | Lucite |
| | promoter | |
| Tyrin 3615 | Chlorinated polyethylene | duPont/Dow |
| Kraton D1155 | Thermoplastic SBS block copolymer | Kraton Polymers |
| Paraloid BTA | 753 MBS Core-shell impact modifier | Rohm & Haas |
| Phosphate ester CD-9052 | Polymerizable acidic adhesion promoter | Sartomer |
| 0.05% CuAcAc Solution | Copper acetyl acetonate solution in MMA | Lab prep/Aldrich |
| Reillcat ASY-2 | Dihydropyridine activator Component | Reilly Industries |
| 2-Butyne-4-diol | Inventive adhesion promoter | BASF |
| Surfynol ® | Inventive commercial adhesion promoters | Air Products |
| 2-Butyne-1,4-diol | Comparative acetylenic compound | Aldrich |
| diacetate | | |

| | Example | | | | | |
|---|---|---|---|---|---|---|
| | A | B | C | D | E | F |
| Components | Control | | | | | |
| Methyl Methacrylate | 63.4 | 61.4 | 61.4 | 61.4 | 61.4 | 61.4 |
| Methacrylic Acid | 2.5 | 2.5 | 2.5 | 2.5 | 2.5 | 2.5 |
| Tyrin 3615 | 5 | 5 | 5 | 5 | 5 | 5 |
| Kraton D1155 | 5 | 5 | 5 | 5 | 5 | 5 |
| p-Toluenesulfonyl Chloride | 1.5 | 1.5 | 1.5 | 1.5 | 1.5 | 1.5 |
| Rohm & Haas BTA-753 | 20 | 20 | 20 | 20 | 20 | 20 |
| Phosphate Ester CD-9052 | 1.25 | 1.25 | 1.25 | 1.25 | 1.25 | 1.25 |
| 0.05% CuAcAc Solution | 0.1 | 0.1 | 0.1 | 0.1 | 0.1 | 0.1 |
| Reillcat ASY-2 | 1.25 | 1.25 | 1.25 | 1.25 | 1.25 | 1.25 |
| 2-Butyne-1,4-diol | — | 2 | — | — | — | — |
| Surfynol ® 104 | — | — | 2 | — | — | — |
| Surfynol 485 | — | — | — | 2 | — | — |
| Surfynol 61 | — | — | — | — | 2 | — |
| 2-Butyne-1,4-diol diacetate | — | — | — | — | — | 2 |
| Acetylenic component | | Inventive | Inventive | Inventive | Single | No |
| features | | Diol | Diol | Diol | OH Group | OH Group |
| Results | | | | | | |
| Aluminum Lap Shear Strength, | 2112 | 2513 | 2308 | 2184 | 2048 | 2153 |
| psi ASTM D1002 | | | | | | |
| Failure Mode | Adhesive | Cohesive/Adh | Adhesive | Adhesive | Adhesive | Adhesive |

Example A is a control Example while the preferred inventive Examples include Examples B-D. These Examples, particularly Examples B and C, disclose improved adhesion for the compositions of preferred embodiments of the invention over compositions that do not include the inventive acetylenic diol component. However, these Examples place no limitations on the scope of the inventions disclosed herein.

1. An adhesive composition comprising one or more vinyl monomers, one or more soluble or dispersible polymers, and an acetylenic diol adhesion promoter.

2. The adhesive composition of claim 1 further comprising a polymerizable acidic adhesion promoter.

3. The adhesive composition of claim 1 wherein the acetylenic diol comprises 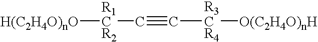
wherein R₁, R₂, R₃, and R₄ are selected from H and alkyl groups and wherein ₙ is equal to or greater than 0.

4. The adhesive composition of claim 1, wherein the acetylenic diol adhesion promoter comprises 2-butyne-1,4-diol.

5. The adhesive composition of claim 1, wherein the acetylenic diol adhesion promoter comprises 2,4,7,9-tetramethyl-5-decyne-4,7-diol.

6. The adhesive composition of claim 1, wherein the acetylenic diol adhesion promoter comprises an ethoxylated 2-butyne-1,4-diol.

7. An organic adhesive composition comprising an acrylate or methacrylate ester monomer, a soluble or dispersible polymer, an acetylenic diol adhesion promoter and a polymerizable acidic adhesion promoter.

8. The adhesive composition of claim 7 wherein the acetylenic diol comprises 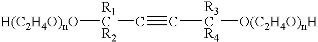
wherein R₁, R₂, R₃, and R₄ are selected from H and alkyl groups and wherein ₙ is equal to or greater than 0.

9. The organic adhesive composition of claim 8, wherein the acetylenic diol adhesion promoter comprises 2-butyne-1,4-diol.

10. The organic adhesive composition of claim 8, wherein the acetylenic diol adhesion promoter comprises 2,4,7,9-tetramethyl-5-decyne-4,7-diol.

11. The organic adhesive composition of claim 8, wherein the acetylenic diol adhesion promoter comprises an ethoxylated 2-butyne-1,4-diol.

12. The adhesive composition of claim 2 wherein the acidic adhesion promoter is selected from the group consisting of unsaturated mono-carboxylic acids, such as acrylic acid and methacrylic acid, unsaturated dicarboxylic acids, such as maleic acid and fumaric acid, unsaturated phosphoric acid esters, such as mono- and bis-methacroyloxyethyl phosphate and mixtures thereof.

13. The organic adhesive composition of claim 7 wherein the acidic adhesion promoter is selected from the group consisting of unsaturated mono-carboxylic acids, such as acrylic acid and methacrylic acid, unsaturated dicarboxylic acids, such as maleic acid and fumaric acid, unsaturated phosphoric acid esters, such as mono- and bis-methacroyloxyethyl phosphate and mixtures thereof.

14. An organic adhesive composition comprising from about 20 to about 90% of a polymerizable vinyl monomer, from about 10% to about 60% of a soluble or dispersible polymer or mixture of polymers, and from about 0.1 to about 10% of an acetylenic diol.

15. The adhesive composition of claim 14 wherein the acetylenic diol comprises 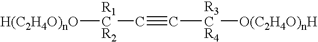
wherein R₁, R₂, R₃, and R₄ are selected from H and alkyl groups and wherein n is equal to or greater than 0.

16. The adhesive composition of claim 14, wherein the acetylenic diol adhesion promoter comprises 2-butyne-i,4-diol.

17. The composition of claim 14 further comprising from about 0.5 to about 20% of a polymerizable acidic adhesion promoter.

18. The adhesive composition of claim 14, wherein the acetylenic diol adhesion promoter comprises 2,4,7,9-tetramethyl-5-decyne-4,7-diol.

19. The adhesive composition of claim 14, wherein the acetylenic diol adhesion promoter comprises an ethoxylated 2-butyne-1,4-diol.

20. The adhesive composition of claim 14 wherein the acidic adhesion promoter is selected from the group consisting of unsaturated mono-carboxylic acids, such as acrylic acid and methacrylic acid, unsaturated dicarboxylic acids, such as maleic acid and fumaric acid, unsaturated phosphoric acid esters, such as mono- and bis-methacroyloxyethyl phosphate and mixtures thereof.

21. A process of adhesively securing metallic substrates comprising
a) preparing the adhesive composition of claim 1, and
b) securing the adhesive composition to metallic substrates.
